(19) United States
(12) Patent Application Publication
(10) Pub. No.: US 2023/0267893 A1
(43) Pub. Date: Aug. 24, 2023

(54) DISPLAY DEVICE AND DRIVING METHOD THEREOF

(71) Applicant: Qisda Corporation, Taoyuan City (TW)

(72) Inventor: Min-An KUO, Hsinchu City (TW)

(73) Assignee: Qisda Corporation, Taoyuan City (TW)

(21) Appl. No.: 17/711,139

(22) Filed: Apr. 1, 2022

(30) Foreign Application Priority Data
Feb. 24, 2022 (CN) 202210174076.0

(51) Int. Cl. G09G 3/36

(52) U.S. Cl. CPC G09G 3/3611; G09G 2320/0626; G09G 2310/08; G09G 2320/0257; G09G 2320/0252

(57) ABSTRACT

A driving method of a display device comprises the following steps. A period to turn off a backlight module is set. An overdrive voltage is applied, and an overdrive time required for a liquid crystal to change from a first target gray scale to a second target gray scale is obtained. A turn-off time point for turning off the backlight module is adjusted so that at least a part of the period when the backlight module is turned off overlaps the overdrive time.

This application claims the benefit of People's Republic of China application Serial No. 202210174076.0, filed Feb. 24, 2022, the subject matter of which is incorporated herein by reference.

### BACKGROUND OF THE INVENTION

### Field of the Invention

The invention relates in general to a display device, and more particularly to a display device and a driving method thereof.

### Description of the Related Art

In terms of a liquid crystal display (LCD), response time of the liquid crystal refers to the average time of a gray scale conversion time from dark to bright and a gray scale conversion time from bright to dark for one pixel. In terms of 8-bit pixels, there are 256 gray scales from brightest to darkest, gray scale 0 being the darkest, and gray scale 255 being the brightest.

Calculated with a common 1080p resolution liquid crystal display, the frame update rate is 60 Hz, that is, a frame update time requires 1/60=16.66 ms. If the liquid crystal response time is greater than this frame update time, it is very easy to see the phenomenon of ghosting.

In order to avoid the phenomenon of ghosting, the blurred image due to ghosting can be reduced by shortening the liquid crystal response time, but shortening the liquid crystal response time will still cause coronas during the overdrive time, and it is necessary to be further improved.

### SUMMARY OF THE INVENTION

The present invention relates to a display device and a driving method thereof, and the effect of clear image is achieved by adjusting the turn-off time point of the backlight module and setting the overdrive time of the liquid crystal.

According to an aspect of the present invention, a method for driving a display device is provided, which includes the following steps. A period to turn off a backlight module is set. An overdrive voltage is applied, and an overdrive time required for a liquid crystal to change from a first target gray scale to a second target gray scale is obtained. A turn-off time point for turning off the backlight module is adjusted so that at least a part of the period when the backlight module is turned off overlaps the overdrive time.

According to an aspect of the present invention, a method for driving a display device is provided, which includes the following steps. When updating a frame, a vertical synchronization signal is received, and a period to turn off a backlight module is set. An overdrive voltage is applied, and an overdrive time required for a liquid crystal from a first target gray scale to a second target gray scale is obtained. A turn-off time point for turning off a backlight module is adjusted so that at least a part of the period when the backlight module is turned off overlaps the overdrive time.

According to an aspect of the present invention, a display device is provided, including a driving voltage module, a backlight module, and an adjustment module. The backlight module is electrically coupled to the driving voltage module. The adjustment module is electrically coupled to the driving voltage module and the backlight module. The backlight module includes a period for turning off the backlight module and a turning-off time point, the driving voltage module includes an overdrive voltage, and an overdrive time required for a liquid crystal to change from a first target gray scale to a second target gray scale. The adjustment module adjusts the turn-off time point so that at least a part of the period when the backlight module is turned off overlaps the overdrive time.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a comparison diagram of an overdrive voltage and a base driving voltage according to an embodiment of the present invention.

FIG. 2 is a schematic diagram of a display device according to an embodiment of the present invention.

FIG. 3 is a schematic diagram illustrating a driving method of a display device according to an embodiment of the present invention.

FIG. 4 is a diagram showing the relationship among the frame update time, the period to turn off the backlight module, and the overdrive time of the liquid crystal according to an embodiment of the present invention.

### DETAILED DESCRIPTION OF THE INVENTION

The following examples are provided for detailed description, and the examples are only used as examples to illustrate, and are not used to limit the scope of protection of the present invention.

The display device can be a liquid crystal display device, and such liquid crystal types are, for example, nematic liquid crystal, smectic liquid crystal, cholesteric liquid crystal, etc. The liquid crystal response time is divided into MPRT (moving picture response time) and GTG (gray-to-gray time), the shorter the liquid crystal response time, the less the user will have the feeling of shadow dragging when watching dynamic pictures. MPRT is the abbreviation of moving picture response time, which is a technical means to reduce the blurring of the picture. For example, the backlight is temporarily turned off during the color conversion process of the screen, and the backlight is turned on after the color conversion process. That is to say, MPRT technology inserts a black frame (turning off the backlight) between the frames by turning off/on the backlight, so as to reduce the display time of each frame on the screen and reduce the persistence effect of the moving picture, so that when the user is playing the game, the phenomenon such as shadow dragging and afterimage of the picture seen by the user is reduced. In terms of a view, MPRT can reduce the phenomenon of shadow dragging and afterimage, but it also causes the problem of dimmed screen brightness.

In addition, GTG (gray to gray time) refers to the liquid crystal response time between different gray scales, that is, the time for the liquid crystal to change from dark to bright or from bright to dark. The liquid crystal can achieve the effect of overdrive by means of response time compensation (RTC), that is, by inserting a compensation voltage between the voltage of the initial gray scale and the voltage of the target gray scale, to accelerate the rotation of liquid crystal molecular to shorten the liquid crystal response time. The compensation voltage is to find the corresponding voltage value by switching the liquid crystal response time of different gray scales, and search the corresponding voltage value from the overdrive voltage look-up table. However, if the compensation voltage is too high, the gray scale change of the liquid crystal molecules is huge, it will also cause shadow dragging on the frame.

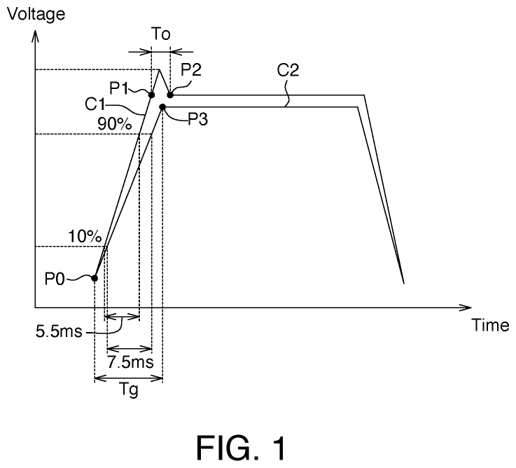

As shown in FIG. 1, FIG. 1 is a comparison diagram of the overdrive voltage C1 and the base driving voltage C2 according to an embodiment of the present invention. The time for applying the overdrive voltage C1 includes the time from the initial gray scale P0 to the first target gray scale P1, the time from the first target gray scale P1 to the second target gray scale P2 (i.e., overdrive time To), and the time from the target gray scale P2 returns to the initial gray scale P0. In addition, the time for applying the base driving voltage C2 includes the time for the liquid crystal from the initial gray scale P0 to the third target gray scale P3 (i.e., basic driving time Tg) and the time from the third target gray scale P3 to the initial gray scale P0. When the third target gray scale P3 is greater than the initial gray scale P0, the display device 100 can use the basic driving time Tg to obtain a rise time, and when the third target gray scale P3 is smaller than the initial gray scale P0, the display device 100 can use the basic driving time Tg to obtain a fall time.

In one embodiment, when the liquid crystal is turned from the initial gray scale P0 (e.g., gray scale 32) to the third target gray scale P3 (e.g., gray scale 48), the required time (the time between 10% to 90% of the basic driving time is calculated) is about 7.5 ms. In order to shorten the response time of the liquid crystal, the compensation voltage is inserted through the effect of overdriving to a higher gray scale (e.g., gray scale 58). Please refer to the curve of the overdrive voltage C1, when the liquid crystal turns from the initial gray scale P0 (e.g., gray scale 32) to the first target gray scale P1 (the time between 10% and 90% of the basic driving time is calculated) is about 5.5 ms, which is less than 7.5 ms required for the liquid crystal to turn from the initial gray scale P0 (e.g., gray scale 32) to the third target gray scale P3 (e.g., gray scale 48), thereby shortening the liquid crystal response time. Afterwards, the gray scale of the liquid crystal will reach a higher gray scale (e.g., gray scale 58) and then return to the second target gray scale P2. Therefore, a shadow dragging will appear on the frame during the overdrive time To.

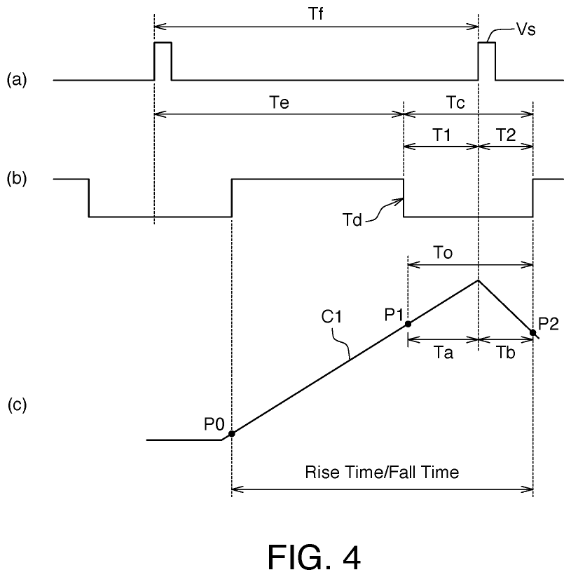

In order to avoid blurring of the picture, in this embodiment, for example, through MPRT technology, the display device 100 sets the period to turn off a backlight module 106 and adjusts the turn-off time point Td of the period to turn off the backlight module 106, so that at least a part of the period Tc when the backlight module 106 is turned off overlaps the overdrive time To (see FIG. 4) to avoid shadow dragging on the frame.

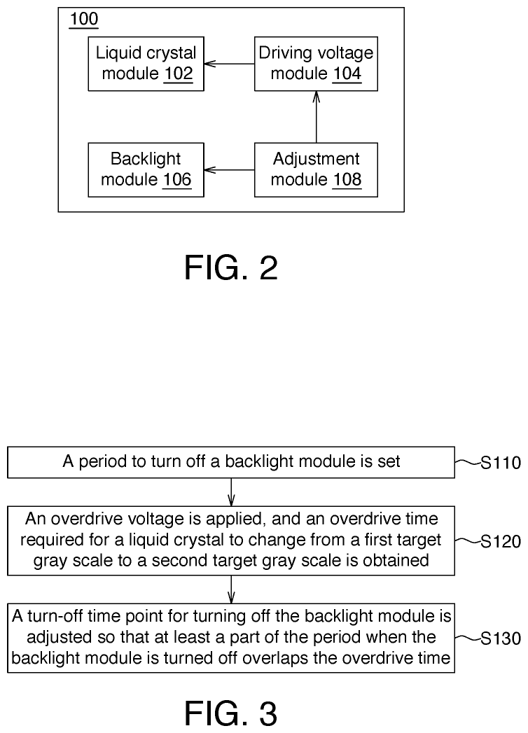

Please refer to FIG. 2 and FIG. 3, FIG. 2 is a schematic diagram of a display device 100 according to an embodiment of the present invention, and FIG. 3 is a schematic diagram of a driving method of the display device 100 according to an embodiment of the present invention. The display device 100 includes a liquid crystal module 102, a driving voltage module 104, a backlight module 106 and an adjustment module 108. The liquid crystal module 102 is electrically coupled to the driving voltage module 104, and the adjustment module 108 is electrically coupled to the driving voltage module 104 and the backlight module 106.

The driving voltage module 104 is used to provide the voltage required for liquid crystal conversion, including the basic driving voltage C2 and the overdrive voltage C1. As shown in FIG. 1, the driving voltage module 104 includes the overdrive time To required by the liquid crystal from the first target gray scale P1 to the second target gray scale P2.

The backlight module 106 is configured to provide backlight to the liquid crystal module 102 so that the display device 100 can generate a frame. In this embodiment, the backlight module 106 is configured to provide a period Tc for turning off the backlight module 106 and a turning off time point Td for turning off the backlight module 106 to meet the overdrive time To provided by the driving voltage module 104.

The adjustment module 108 is used to adjust the turn-off time point Td, so that the period Tc for turning off the backlight module 106 at least partially overlaps the overdrive time To. That is to say, the display device 100 can set the turn-off time point Td for turning off the backlight module 106 according to the overdrive time To required for the liquid crystal gray scale conversion.

As shown in FIG. 1 to FIG. 4, the driving method of the display device 100 includes the following steps. In step S110, a period Tc to turn off a backlight module 106 is set. In step S120, an overdrive voltage C1 is applied, and an overdrive time To required for a liquid crystal to change from a first target gray scale P1 to a second target gray scale P2 is obtained. In step S130, a turn-off time points Td for turning off the backlight module 106 is adjusted so that at least a part of the period Tc when the backlight module 106 is turned off overlaps the overdrive time To.

Please refer to FIG. 4, FIG. 4 is a diagram showing the relationship among the frame update time Tf, the period Tc for turning off the backlight module 106, and the overdrive voltage C1 of the liquid crystal according to an embodiment of the present invention. FIG. 4(a) shows the time axis of the frame update time Tf, that is, the time required for updating a picture frame. Taking the frame update rate of 60 Hz as an example, the frame update time Tf is 1/60=16.66 ms. The display device 100 generates a vertical synchronization signal Vs each time a frame is replaced to notify the driving voltage module 104, the backlight module 106 and the adjustment module 108.

FIG. 4(b) is the time axis of the backlight module 106. The period Tc for turning off the backlight module 106 is determined by the brightness. For example, the maximum brightness of the backlight module 106 is 400 nits. Acceptable average brightness after turning off the backlight module 106 is, for example, 200 nits, which is about half the maximum brightness. In order to adjust the period Tc for turning off the backlight module 106, the display device 100 can set the period Tc for turning off the backlight module 106 according to the brightness adjustment ratio. For example, when the brightness adjustment ratio is 0.5, the period Tc for turning off the backlight module 106 is set as half of the frame update time Tf, about 16.66/2=8.33 ms.

In FIG. 4(b), the period Tc for turning off the backlight module 106 includes a first duration T1 and a second duration T2, wherein the first duration T1 is a ratio of rise time to the rise time and the fall time allocated for the period Tc for turning off the backlight module 106. The second duration T2 is a ratio of fall time to the rise time and the fall time allocated for the period Tc for turning off the backlight module 106. It is expressed as follows:

The first duration T1=(time to turn off the backlight)*[rise time/(rise time+fall time)]; and

The second duration T2=(time to turn off the backlight)*[fall time/(rise time+fall time)].

In FIG. 1, when the display device 100 is driven with a basic driving voltage C2, a basic driving time Tg required for the liquid crystal to change from an initial gray scale P0 to a third target gray scale P3 is obtained. A rise time is obtained by using the basic driving time Tg when the third target gray scale P3 is greater than the initial gray scale P0, and a fall time is obtained by using the basic driving time Tg when the third target gray scale P3 is less than the initial gray scale P0. In one embodiment, according to the gray scale response time table, the average response time of each color scale is the total average of all values, e.g., 11.72 ms, wherein the average rise time is 12.89 ms, and the average fall time is 10.55 ms. The ratio of the rise time [12.89/(12.89+10.55)] and the ratio of the fall time [10.55/(12.89+10.55)] are 55% and 45% respectively, so that the first duration [T1=8.33*0.55] allocated in the period Tc to turn off the backlight in FIG. 4(b) before the vertical sync signal Vs is reached is about 4.58 ms, and the second duration [T2=8.33*0.45] allocated in the period Tc to turn off the backlight after the vertical sync signal Vs is reached is about 3.74 ms.

According to the above description, the display device 100 can set the turn-off time point Td to turn off the backlight module 106 according to the ratio of the rise time and the ratio of the fall time, and can set a boundary response time Te according to the turn-off time point Td to turn off the backlight module 106. It can be seen from FIG. 4(b) that the boundary response time Te is the frame update time Tf minus the first duration T1, that is, Tf-T1=Te. In one embodiment, the boundary response time Te is, for example, 16.66-4.58=12.08 ms.

When the basic driving time Tg is greater than the boundary response time Te (e.g., 12.08 ms), the overdrive voltage C1 is applied to shorten the basic driving time Tg and make the shortened basic driving time Tg approach to the boundary response time Te. Conversely, when the basic driving time Tg is less than the boundary response time Te (e.g., 12.08 ms), the basic driving voltage C2 is still applied, and the overdrive voltage C1 does not need to be applied. In one embodiment, the response time of the liquid crystal from gray scale 0 to gray scale 32 is, for example, 15.91 ms, and the overdrive voltage C1 can be applied to a higher gray scale (e.g., gray scale 41) to shorten the liquid crystal response time to 12 ms (less than the boundary response time Te). In the same way, the display device 100 can adjust gray scale of other liquid crystal whose response time is higher than the boundary response time Te, which will not be repeated here.

FIG. 4(c) is the time axis of the overdrive voltage C1 of the liquid crystal. The overdrive time To includes a first overdrive time Ta and a second overdrive time Tb, wherein the first overdrive time Ta is, for example, the time from the first target gray scale P1 to a higher gray scale of the liquid crystal, the second overdrive time Tb is, for example, the time for the liquid crystal to return from a higher gray scale to the second target gray scale P2.

As can be seen from the timing of FIG. 4(b) and FIG. 4(c), the display device 100 sets a first duration T1 to turn off the backlight module 106 before receiving the vertical synchronization signal Vs, and sets a second duration T2 to turn off the backlight module 106 after receiving the vertical synchronization signal Vs, wherein the first duration T1 overlaps at least a part of the first overdrive time Ta, and the second duration T2 overlaps at least a part of the second overdrive time Tb. That is to say, the time (the overdrive time To) for shadow dragging due to overdrive is substantially the same as and overlaps the period Tc for turning off the backlight module 106, wherein the first duration T1 is substantially equal to the first overdrive time Ta, the second time period T2 is substantially equal to the second overdrive time Tb.

Since the shadow dragging of the image caused by the overdrive is just within the period Tc when the backlight module 106 is turned off, the user cannot see the shadow dragging that causes the blurred image, and the response time of each frame can be optimized to achieve a clear image effect.

As can be seen from the above description, the display device and the driving method thereof according to the above embodiments of the present invention, by turning off/on the backlight, a black picture is inserted between the pictures to reduce the display time of each frame on the screen, it can reduce the persistence effect of the image, and at the same time, the adjustment module can adjust the turn-off time point of the backlight module, so that a period to turn off the backlight module at least partially overlaps the overdrive time. Therefore, during the period when the backlight module is turned off, the shadow dragging of the image caused by overdrive will not be seen by the user, and thus the effect of clear image is achieved.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A driving method of a display device, comprising:
setting a period to turn off a backlight module;
applying an overdrive voltage to obtain an overdrive time required for a liquid crystal to change from a first target gray scale to a second target gray scale; and
a turn-off time point for turning off the backlight module is adjusted so that at least a part of the period when the backlight module is turned off overlaps the overdrive time,
wherein the display device receives a vertical synchronization signal when updating a frame, and the vertical synchronization signal is within a period that the overdrive time and the period to turn-off the backlight module are overlapped.

2. The driving method according to claim 1, wherein the period to turn off the backlight module comprises a first duration and a second duration, and the overdrive time comprises a first overdrive time and a second overdrive time, the first duration overlaps at least a part of the first overdrive time, and the second duration overlaps at least a part of the second overdrive time.

3. The driving method according to claim 1, wherein the backlight module has a brightness adjustment ratio, and the display device sets the period to turn off the backlight module according to the brightness adjustment ratio.

4. The driving method according to claim 2, when the display device is driven with a basic driving voltage, a basic driving time required for the liquid crystal to change from an initial gray scale to a third target gray scale is obtained, wherein when the third target gray scale is greater than the initial gray scale, a rise time is obtained by using the basic driving time, and when the third target gray scale is smaller than the initial gray scale, a fall time is obtained by using the basic driving time, wherein the first duration is a ratio of the rise time to the rise time and the fall time allocated for the period for turning off the backlight module, and the second duration is a ratio of fall time to the rise time and the fall time allocated for the period for turning off the backlight module.

5. The driving method according to claim 2, wherein the display device sets the first duration to turn off the backlight module before receiving the vertical synchronization signal, and sets the second duration to turn off the backlight module after receiving the vertical synchronization signal, wherein the first duration is substantially equal to the first overdrive time, the second duration is substantially equal to the second overdrive time.

6. The driving method according to claim 4, wherein the display device has a frame update time, and the frame update time minus the first duration is defined as a boundary response time, when the basic driving time is greater than the boundary response time, the overdrive voltage is applied to shorten the base drive time and make the shortened base drive time approach to the boundary response time.

7. The driving method of claim 1, wherein the adjustment module adjusts the turn-off time point so that the period to turn off the backlight module corresponds to and is equal to the overdrive time.

8. A driving method for a display device, comprising:
receiving a vertical sync signal when updating a frame, and setting a period to turn off a backlight module;
applying an overdrive voltage, and obtaining an overdrive time for a liquid crystal from a first target gray scale to a second target gray scale; and
a turn-off time point for turning off the backlight module is adjusted so that at least a part of the period when the backlight module is turned off overlaps the overdrive time,
wherein the vertical synchronization signal is within a period that the overdrive time and the period to turn-off the backlight module are overlapped.

9. The driving method according to claim 8, wherein the backlight module has a brightness adjustment ratio, and the display device sets the period to turn off the backlight module according to the brightness adjustment ratio.

10. The driving method according to claim 8, wherein the period to turn off the backlight module comprises a first duration and a second duration, and the overdrive time comprises a first overdrive time and a second overdrive time, the first duration overlaps at least a part of the first overdrive time, and the second duration overlaps at least a part of the second overdrive time.

11. The driving method according to claim 10, when the display device is driven with a basic driving voltage, a basic driving time required for the liquid crystal to change from an initial gray scale to a third target gray scale is obtained, wherein when the third target gray scale is greater than the initial gray scale, a rise time is obtained by using the basic driving time, and when the third target gray scale is smaller than the initial gray scale, a fall time is obtained by using the basic driving time, wherein the first duration is a ratio of the rise time to the rise time and the fall time allocated for the period for turning off the backlight module, and the second duration is a ratio of fall time to the rise time and the fall time allocated for the period for turning off the backlight module.

12. The driving method according to claim 10, wherein the display device sets the first duration to turn off the backlight module before receiving the vertical synchronization signal, and sets the second duration to turn off the backlight module after receiving the vertical synchronization signal, wherein the first duration is substantially equal to the first overdrive time, the second duration is substantially equal to the second overdrive time.

13. The driving method according to claim 11, wherein the display device has a frame update time, and the frame update time minus the first duration is defined as a boundary response time, when the basic driving time is greater than the boundary response time, the overdrive voltage is applied to shorten the base drive time and make the shortened base drive time approach to the boundary response time.

14. A display device, comprising:
a driving voltage module;
a backlight module electrically coupled to the driving voltage module; and
an adjustment module electrically coupled to the driving voltage module and the backlight module,
wherein the backlight module comprises a period to turn off the backlight module and a turn-off time point,
the driving voltage module comprises an overdrive voltage, and an overdrive time required for a liquid crystal to change from a first target gray scale to a second target gray scale,
the adjustment module adjusts the turn-off time point so that at least a part of the period to turn off the backlight module overlaps the overdrive times,
wherein the display device receives a vertical synchronization signal when updating a frame, and the vertical synchronization signal is within a period that the overdrive time and the period to turn-off the backlight module are overlapped.

15. The display device according to claim 14, wherein the period to turn off the backlight module comprises a first duration and a second duration, and the overdrive time comprises a first overdrive time and a second overdrive time, the first duration overlaps at least a part of the first overdrive time, and the second duration overlaps at least a part of the second overdrive time.

16. The display device according to claim 14, wherein the backlight module has a brightness adjustment ratio, and the adjustment module sets the period to turn off the backlight module according to the brightness adjustment ratio.

17. The display device of claim 15, wherein the driving voltage module further comprises a basic driving voltage and a basic driving time required for the liquid crystal to change from an initial gray scale to a third target gray scale, wherein when the third target gray scale is greater than the initial gray scale, a rise time is obtained by using the basic driving time, and when the third target gray scale is smaller than the initial gray scale, a fall time is obtained by using the basic driving time, wherein the first duration is a ratio of the rise time to the rise time and the fall time allocated for the period for turning off the backlight module, and the second duration is a ratio of fall time to the rise time and the fall time allocated for the period for turning off the backlight module.

18. The display device according to claim 15, wherein the display device sets the first duration to turn off the backlight module before receiving the vertical synchronization signal, and sets the second duration to turn off the backlight module after receiving the vertical synchronization signal, wherein the first duration is substantially equal to the first overdrive time, the second duration is substantially equal to the second overdrive time.

19. The display device according to claim 17, wherein the display device has a frame update time, and the frame update time minus the first duration is defined as a boundary response time, when the basic driving time is greater than the boundary response time, the overdrive voltage is applied to shorten the base drive time and make the shortened base drive time approach to the boundary response time.

20. The display device according to claim 14, wherein the adjustment module adjusts the turn-off time point so that the period to turn off the backlight module corresponds to and is equal to the overdrive time.
